(19) United States
(12) Patent Application Publication
(10) Pub. No.: US 2017/0280096 A1
(43) Pub. Date: Sep. 28, 2017

(54) RECOIL ACTIVATED VIDEO RECORDING THROUGH A DIGITAL IMAGING SYSTEM

(71) Applicant: Marc Vayn, South San Francisco, CA (US)

(72) Inventor: Marc Vayn, South San Francisco, CA (US)

(21) Appl. No.: 15/077,787

(22) Filed: Mar. 22, 2016

(51) Int. Cl. H04N 5/77; F41G 1/38; F41G 11/00; G11B 20/10

(52) U.S. Cl. CPC H04N 5/772; G11B 20/10527; F41G 1/38; F41G 11/00; G11B 2020/1062; G11B 2020/10537

(57) ABSTRACT

The present invention relates to implementing recoil activated video recording through a digital imaging system, wherein the video recording is initiated as the digital imaging system detects a firing event from a smart weapon scope device. The digital imaging system captures the video recording sequence, wherein the sequence captures the video at the specific instance when the firing event is detected, for a specific period of time before the firing event is detected, and for a specific period of time after the firing event is detected.

### FIELD OF THE INVENTION

The present invention generally relates to a digital imaging system and more particularly relates to implementing recoil activated video recording through a digital imaging system, wherein the video recording is initiated as the digital imaging system detects a firing event from a smart weapon scope device.

### BACKGROUND OF THE INVENTION

The present invention relates, in general, to the field of digital imaging system. More particularly, this invention relates to a digital video capturing by a digital video recorder that is mounted on a personal firearm.

In some hunting or combat situations it is important to video record the scene of the action during the critical moment that happens around the time when the weapon fires. Prior to this invention, users have to rely on performing manual operations to begin video recording. In doing so, they risk a failure to produce such recording if the situation in the scene changes suddenly and they must fire their weapon without allowing themselves an opportunity to manually start the recording ahead of the shot. To avoid such risk, users are forced to start the video recording at an arbitrary time before the anticipated firing event, thus, potentially, generating unnecessarily lengthy footages of non-essential video recordings and, furthermore, assuming the risk of running out of the storage capacity of the digital video recording.

Hence, there is a need for a method in the digital imaging system that automates the start of the video recording by monitoring the state of the firearm system and triggering the beginning of the recording when the system detects the firing event.

### SUMMARY OF THE INVENTION

The present invention relates to implementing a system and method for automatically triggering video recording based on recoil activation detected in a smart weapon scope device, wherein the method comprises of buffering the video captured within the scope lens of the smart weapon scope device, identifying a shooting activity initiated through the smart weapon scope device using a digital accelerometer sensor, triggering video recording based on the shooting activity identified in the smart weapon scope device; and storing the video recording in a sequence that is captured prior to the shooting activity, during the shooting activity, and a certain time after the shooting activity.

### BRIEF DESCRIPTION OF DRAWINGS

FIG. 1 illustrates a working overview of a system for implementing the recoil activation triggered video recording mechanism in a digital imaging system.

FIG. 2 illustrates a flow-chart that explains the working of the system implementing the recoil activation triggered video recording mechanism.

FIG. 3 illustrates an overview of components used for implementing the recoil activation triggered video recording mechanism in the digital imaging system.

### FIGUREDESCRIPTION

100—Depicts a working overview of the system
101—Video content as scene by the scope
102—The video content buffered before triggering the recording
103—A point at which the video recording is triggered
104—The video content captured and stored for a time-period elapsed after the video recording is triggered.
200—A flow-chart explaining the process of recording the video content based on the recoil activation trigger
300—A system overview of components used to implement the method of recording the video content based on the recoil activation trigger
301—A Scope module
302—A Trigger Identification module
303—A Storage module
304—A Display module
305—A control module

### DETAILED DESCRIPTION OF THE INVENTION

The following detailed description of the preferred embodiments presents a description of certain specific embodiments to assist in understanding the claims. However, the present invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be evident to one of ordinary skill in the art that the present invention may be practiced without these specific details.

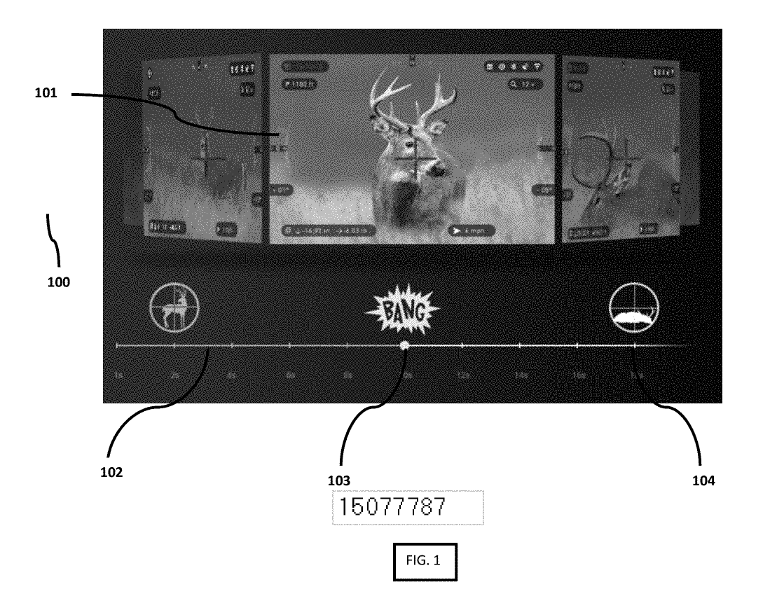

Referring to FIG. 1 illustrates a working overview of the system 100 used for implementing the recoil activation triggered video recording mechanism. In an embodiment, the smart weapon scope continues to buffer the video content 101 within the coverage area. Further, as the smart weapon scope captures the video content 101, the system 100 starts buffering the video content into a temporary storage 102 area until the user triggers the shooting event. As the user triggers the shooting event 103, the system 100 automatically captures the video content at that specific instance and further the system 100 automatically continues to capture the video content for a specific instance of time 104. In an embodiment, the system 100 identifies a shooting activity triggered through the smart weapon scope device using a digital accelerometer sensor.

In an embodiment, prior to detecting that the shot has been fired, the system 100 is considered to be in the pre-recording state. During the pre-recording state, the system 100 continuously captures and overwrites the image from the scene to a temporary video buffer of a predetermined or user specified size. Further, as the shot is fired, a recoil force will be applied to the firearm in the direction opposite of the motion of the projectile. The acceleration that is associated with the recoil force will be detected by the system 100 using the data provided by the digital accelerometer sensor and interpreted as the shot firing event. Further, as the system 100 detects the shot firing event, the pre-recorded video footage will be transferred to a permanent storage and subsequent video recording will be appended to the pre-recorded video footage to create a continuous footage of the scene (video recording) before and after the shot was fired.

Further, the system 100 is configured to store the sequence of the video content captured before triggering the shooting event, at the moment of triggering the shooting event, and for a specific amount of time after triggering the shooting event. The user can later view the recorded and stored sequence of the video content.

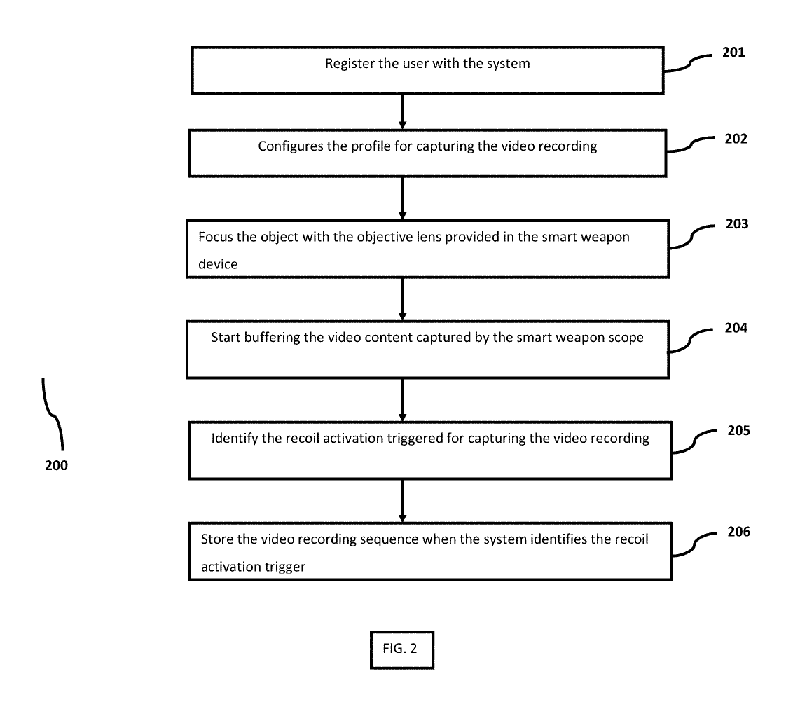

Referring to FIG. 2 illustrates a flow-chart 200 that explains the working of the system 100 implementing the recoil activation triggered video recording mechanism. Initially, at step 201, the user registers with the system 100 for automatically capturing the video content 101 as the recoil activation is triggered through the smart weapon scope device. Further, at step 202, as the user successfully registers with the system 100, the system 100 allows the registered user to configure the profile in the smart weapon scope device for capturing the video content as the recoil activation is triggered. Further, at step 203, the system 100 is configured to allow the user to focus and capture the object within the smart weapon scope. Further, at step 204, the system 100 is configured to buffer the video content that is captured within the smart weapon scope. Further, at step 205, the system 100 is configured to identify the recoil activation triggered for automatically capturing the video content at that specific instance of time. Further, at step 206, the system 100 is configured to capture and store the video content that is recorded when the recoil activation is triggered, a few seconds/minutes before the recoil activation is triggered, and for few seconds/minutes after the recoil activation is triggered.

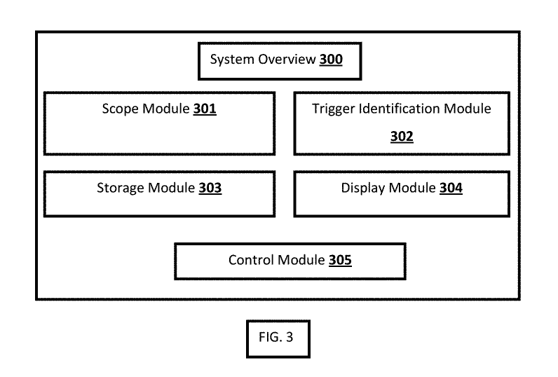

Referring to FIG. 3 illustrates an overview of components 300 used for implementing the recoil activation triggered video recording mechanism through the digital imaging system 100. In an embodiment, the following components 300 are used for implementing the recoil activation triggered video recording mechanism through the digital imaging system 100: a Scope module 301, a Trigger Identification module 302, a Storage module 303, a Display module 304, and a Control module 305. The Scope module 301 is configured to capture the objects identified within the smart weapon scope. The Trigger Identification module 302 is configured to identify the triggering event initiated through the smart weapon scope device. The Storage module 303 is configured to record and store the sequence of video captured just before the firing event, that activates the recoil, is initiated through the smart weapon scope device, at the instance when the recoil event is activated/triggered, for a specific instance of time after the recoil event is activated/triggered by the digital imaging system. The Display module 304 is configured to display the video recordings captured and stored in the digital imaging system. The Control module 305 is configured to transfer data across the modules supported by the system 100.

1. A method for automatically triggering video recording based on recoil activation detected in a smart weapon scope device, wherein said method comprises of:
buffering the video captured within the smart weapon scope device;
identifying a shooting event initiated through said smart weapon scope device using a digital accelerometer sensor;
triggering video recording automatically at the instance of the shooting event identified for the smart weapon scope device; and
storing the video recording in a sequence that is captured prior to the shooting event, at the instance of the shooting event, and for a specific instance of time after the shooting event.

2. The method as claimed in claim 1, wherein said smart weapon scope device comprises of a digital imaging system that is capable of video recording through said digital accelerometer sensor.

3. The method as claimed in claim 1, wherein the method identifying the shooting event activates the recoil for triggering video recording.

4. The method as claimed in claim 1, wherein the method considers the system to be in the pre-recording state prior to detecting that the shot has been fired.

5. The method as claimed in claim 4, wherein the method continuously captures and overwrites the video recording to a temporary video buffer of a predetermined or user specified size during the pre-recording state.

6. A digital imaging system for automatically triggering video recording based on recoil activation detected in a smart weapon scope device, wherein said system comprises of a digital accelerometer sensor and is configured to:
buffer the video captured within the smart weapon scope device;
identify a shooting event initiated through said smart weapon scope device using said digital accelerometer sensor;
trigger video recording based on the shooting event identified in the smart weapon scope device; and
store the video recording captured prior to the shooting event, at the instance of the shooting event, and for a specific instance of time after the shooting event.

7. The system as claimed in claim 6, wherein the system is configured to identify the shooting event to activate the recoil for triggering video recording.

8. The system as claimed in claim 6, wherein the system is configured to be in the pre-recording state prior to detecting that the shot has been fired.

9. The system as claimed in claim 8, wherein the system is configured to continuously capture and overwrite the video recording to a temporary video buffer of a predetermined or user specified size during the pre-recording state.

10. A computer program product comprising computer executable program code recorded on a computer readable non-transitory storage medium, said computer executable program code when executed implements a recoil activated video recording through a digital imaging system, causing the actions including:
buffering the video captured within the smart weapon scope device;
identifying a shooting event initiated through said smart weapon scope device using a digital accelerometer sensor;
triggering video recording automatically based on the shooting event identified through the smart weapon scope device; and
storing the video recording in a sequence that is captured prior to the shooting event, at the instance of the shooting event, and for a specific instance of time after identifying the shooting event.

11. The computer program product as claimed in claim 10, wherein said smart weapon scope device comprises of a digital imaging system that is capable of video recording through said digital accelerometer sensor.

12. The computer program product as claimed in claim 10, wherein the product is configured to identify the shooting event to activate the recoil for triggering video recording.

13. The computer program product as claimed in claim 10, wherein the product is configured to be in the pre-recording state prior to detecting that the shot has been fired.

14. The computer program product as claimed in claim 13, wherein the product is configured to continuously capture and overwrite the video recording to a temporary video buffer of a predetermined or user specified size during the pre-recording state.
